(19) United States
(12) Patent Application Publication
(10) Pub. No.: US 2006/0225591 A1
(43) Pub. Date: Oct. 12, 2006

(54) Automatic die-cutting stamping machine of platen flat double-set type

(76) Inventor: Tian-Sheng Liu, Panchiao City (TW)

Correspondence Address: Tian-Sheng Liu, P.O. Box No. 6-57, Junghe, Taipei, 235, TW

(21) Appl. No.: 11/100,498

(22) Filed: Apr. 7, 2005

(51) Int. Cl. B41F 13/56

(52) U.S. Cl. 101/226

(57) ABSTRACT

An automatic die-cutting stamping machine of platen flat double-set type includes a sheet conveying unit, two dieing units, two aluminum foil controlling units, a transversal aluminum foil controlling unit and a sheet delivery unit. The position sequence of various units mentioned above includes: paper conveying unit+dieing unit of first group+aluminum foil controlling unit of first group+aluminum foil controlling unit of second group+dieing unit of second group (+transversal aluminum foil controlling unit)+sheet delivery unit; the sheet conveying unit uses the automatic vacuum paper sending device for continuous action of sheet handing over to the gripper row; two dieing units use the symmetrical crank-connecting rod mechanism for movement of the moving platform; the synchronism of the moving platform movements of two dieing unit uses two synchronous pulleys of the parallel type driven by a motor thereby implementing synchronous driving.

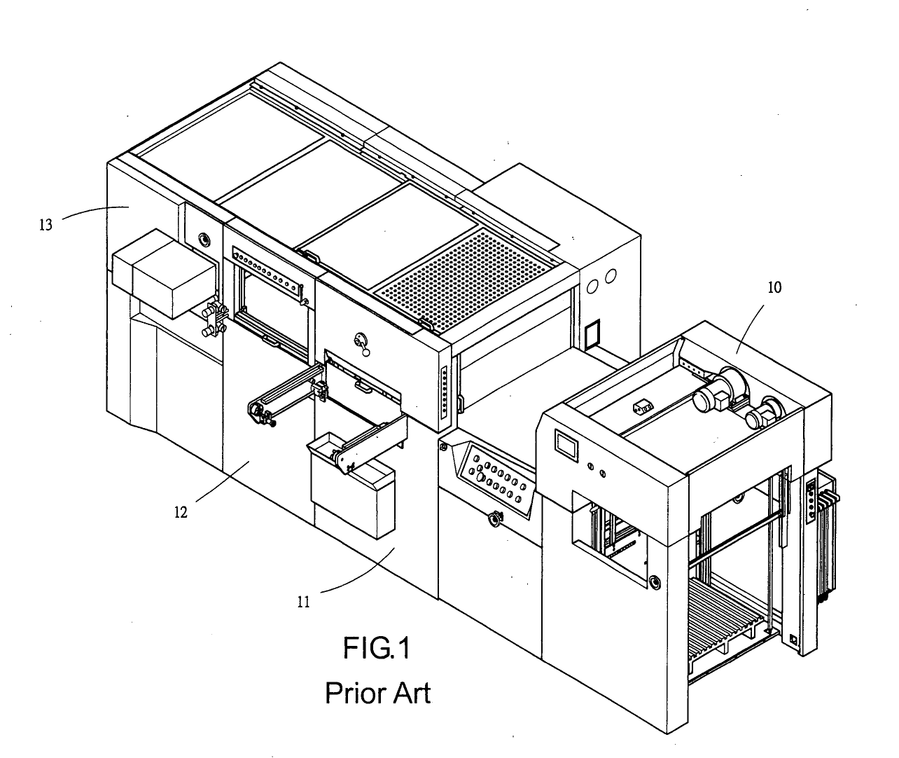

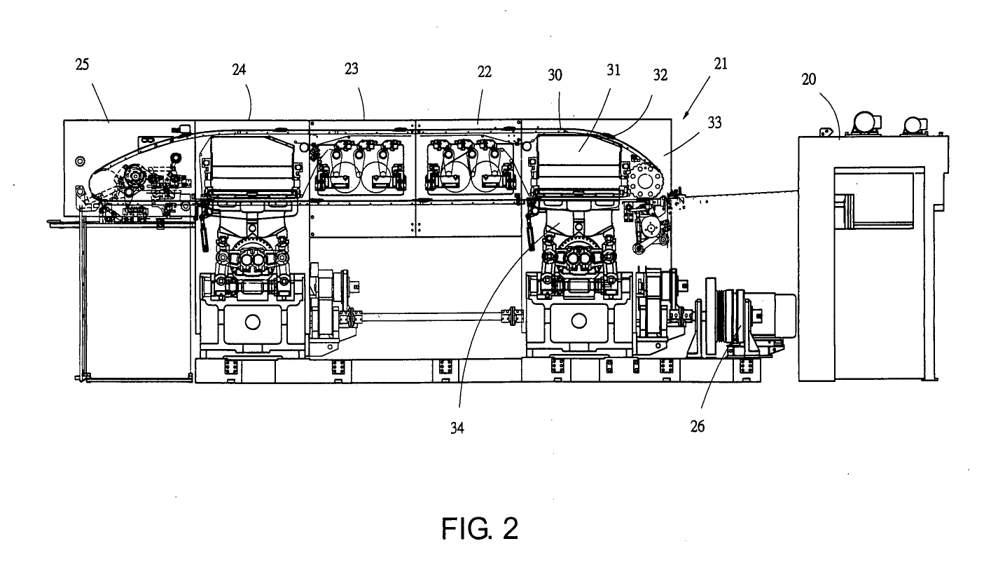

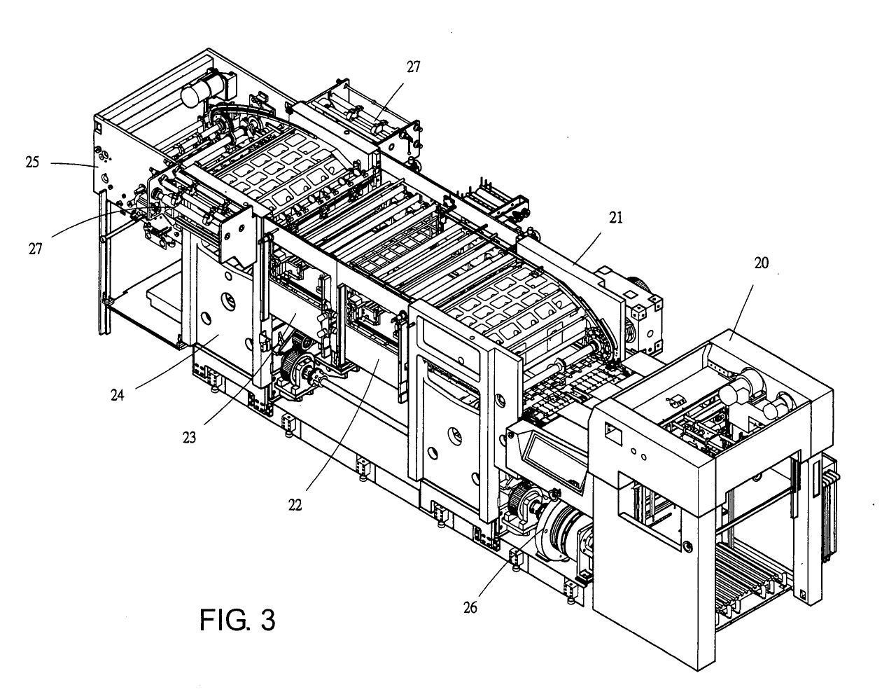

### BACKGROUND OF THE INVENTION

(a) Field of the Invention

This creation relates to a kind of printing machinery, especially is an automatic die-cutting stamping machine of platen flat double-set type that could solve the multi-time printing, stamping, die-cutting etc. working positions in one paper-traveling. It belongs to the technological domain of the automatic die-cutting stamping machine with the improving type of a new generation.

(b) Description of the Prior Art

With the development of the printing and packaging trade, the printing firms maintain usually the position in the trade with the complex, Hi-Tech printing technology. Due to the continuous increasing of the requirements on the printing technology and the chromatography accuracy, it makes the existing platen flat die-cutting stamping machine difficult to adapt to the high requirements on the high chromatography accuracy of the printing products.

It is known from above mentioned that for the traditional automatic die-cutting stamping machine of the platen flat type, the three dimensional drawing of the composition of every part is shown on Figure One, conventionally, it includes following contents:

First, it includes a sheet conveying unit 10, said unit could be manual or automatic. Every paper sheet is picked up sheet by sheet from the paper pile and is conveyed to a sheet conveying table, on this conveying table, every sheet must be positioned by leaning against the front guard gauge and side gauge. The front edge of the sheet after the positioning is clipped by the gripper row one by one and is sent- to the subsequent processing table, two ends of the gripper row are fixed on two enclosed and mutually parallel driving chains at its two sides, the gripper row moves in circulation with the driving chain, its driving device is an intermittent driving mechanism, implementing the cycled alternative acting process of the gripper row's moving and stopping.

The subsequent dieing unit 11 is a paper product processing unit. Said unit includes the fixed platform, moving platform, the mechanism implementing the movement of the moving platform, and the framework that bears the force produced by the mutual action of the fixed platform and the moving platform. The moving platform uses the connecting rod mechanism or cam mechanism for implementing the up/down reciprocating movement, after auxiliary tools were mounted on two platforms, and when they contacted mutually said device produces a pressure, and thus the transfer printing is implemented. After mounted with the die-cutting or indenting tools separately, the fixed platform and moving platform could implement the sheet cutting or indentation pressing function. After the heating system and stamping tools were assembled on the fixed platform, then the stamping function could be implemented. When the gripper row carrying the paper sheet stops at said unit, the action of stamping or die-cutting is implement.

After the stamping or die-cutting was completed, the gripper row continues to bring the gripped sheet sequentially to the aluminum foil controlling unit 12 (or the waste edge removing unit) and the sheet delivery unit 13. The aluminum controlling unit 12 is a control device controlling the conveying length of the aluminum foil (transfer printing material) to be stamped in every stamping. In which the sending (or drawing) mechanism and recovering mechanism of the transfer printing material are included. The aluminum foil needs to pass through between the fixed platform and moving platform of the dieing unit 11, when the dieing unit 11 produces a pressure, the transfer printing is carried out.

The sheet delivery unit 13 is a device used for delivering the printing product after it is stamped or die-cut and waste edge removed, and for uniformity making of the printing product. Said unit includes the mechanism that makes the gripper row release the sheet and the mechanism that makes the sheet delivered in uniformity.

After the sheet was gripped by the gripper row on the sheet conveying unit 10, it passes the dieing unit 11, aluminum foil controlling unit 12 (or waste edge removing unit), sheet delivery unit 13, then one sheet-traveling process is completed.

The traditional automatic die-cutting stamping machine of the platen flat type mentioned above, has following combination manners according to its various working units: conveying unit+dieing unit+aluminum foil controlling unit+(or waste edge removing unit)+sheet delivery unit. There is only one group of dieing unit for one set of machine (called as single set), therefore, on one set of said machine, only one kind could be selected among the two working manners of the die-cutting waste edge removing and stamping, i.e. one sheet traveling could implement only one stamping, or one sheet traveling implements the single function of one die-cutting. For the willing of implementing two stampings, or the complex action of stamping first and then die-cutting, it could be implemented only by sheet traveling twice. And due to the processing accuracy of the equipment, the error of the positioning accuracy, the deformation of the sheet etc. reasons, even the repeated stamping etc. works are implemented by sheet traveling many times it is also difficult to reach the ideal condition. Therefore, extremely large rate of waste product may occur, the processing cost is increased, and the waste is resulted in.

### SUMMARY OF THE INVENTION

In consideration of this, this creation provided an automatic die-cutting stamping machine of the platen flat double-set type, it could improve effectively above traditional shortcomings.

That is to say, the main purpose of this creation is to provide a die-cutting stamping design of the platen flat double-set type, an automatic die-cutting stamping machine of platen flat double-set type that could solve the multi-time printing, stamping, die-cutting etc. working positions in one paper-traveling.

The automatic die-cutting stamping machine of platen flat double-set type of this creation increased mainly the synchronous driving device of the dieing unit and the unit of two dieing sets on the current die-cutting stamping machine, for implementing the completion of repeated stamping in one paper traveling or implementing the die-cutting after the stamping is completed, or other works that could be completed originally by using two sets of platen flat automatic die-cutting stamping machine separately after the paper traveled sequentially.

According to those mentioned above, the automatic die-cutting stamping machine of platen flat double-set type of this creation could reach the purpose of increasing the product efficiency under the machine runs with the equal working speed, could accomplish the product processing work that is unable to be completed by using the traditional platen flat automatic die-cutting stamping machine, could reduce the sheet traveling times of the sheet, shorten the time interval of processing many times, could reduce the sheet deformation caused by the processing, increase the accuracy of chromatography of the repeated stamping, control effectively the waste product rate of the printing product, expand the fabricating scope of the stamping technology, and increase the counterfeit resistant ability.

For reaching the purposes mentioned above, this creation uses following technical measures:

The automatic die-cutting stamping machine of platen flat double-set type is constituted by composing of a sheet conveying unit, two dieing units, two aluminum foil controlling units, a transversal aluminum foil controlling unit and a sheet delivery unit.

According to the paper traveling sequence of the die-cutting stamping machine, the position sequence of various units mentioned above on the machine includes: paper conveying unit+dieing unit of the first group+aluminum foil controlling unit of the first group+aluminum foil controlling unit of the second group+dieing unit of the second group (+transversal aluminum foil controlling unit)+sheet delivery unit; in which, the sheet conveying unit uses the automatic vacuum paper sending device, for implementing the continuous action of sheet handing over to the gripper row sheet by sheet; two dieing units use the symmetrical crank-connecting rod mechanism, for implementing the movement of the moving platform; the synchronism of the moving platform movements of two dieing unit uses two parallel type synchronous pulleys driven by a motor, for implementing the action of synchronous driving.

In the actual implementation example of this creation, for its six working units, according to the front and back sequence of the paper traveling, there could be also different combinations for implementing the same function.

A transversal aluminum foil controlling unit could be also increased on two dieing units, for implementing more product processing functions. Said transversal aluminum foil control unit is a control device controlling the conveying length of the aluminum foil (transfer printing material) to be stamped during every stamping. In which the sending (or drawing) mechanism and recovering mechanism of the transfer printing material are included, for implementing the sending of the transfer printing material before every stamping and the recovering of the waste material after the stamping. The aluminum foil needs to pass through between the fixed platform and moving platform of the dieing unit, when the dieing unit produces a pressure, the transfer printing is implemented. Its feature is that the passing through direction of the aluminum foil crosses vertically to the movement direction of the sheet.

To enable a further understanding of the said objectives and the technological methods of the invention herein, the brief description of the drawings below is followed by the detailed description of the preferred embodiments.

### BRIEF DESCRIPTION OF THE DRAWING

Figure One is the three dimensional drawing of various units' composition of the traditional automatic die-cutting stamping machine of the platen flat type.

Figure Two is the plane drawing of various units' composition of the automatic die-cutting stamping machine of the platen flat double-set type of this creation.

Figure Three is the three dimensional drawing of an implementation example's composition of the automatic die-cutting stamping machine of the platen flat double-set type of this creation.

### DETAILED DESCRIPTION OF THE PREFERRED EMBODIMENTS

The below attached Figure Two is the plane drawing of the combination of various units of the automatic die-cutting stamping machine of the platen flat double-set type of this creation.

Figure Three is the three dimensional drawing of an implementing example combination of the automatic die-cutting stamping machine of the platen flat double-set type of this creation.

As shown on Figure Two and Figure Three, the automatic die-cutting stamping machine of the platen flat double-set type of this creation is constituted mainly by composing of a sheet conveying unit (20), two dieing units (21, 24), two aluminum foil controlling units (22, 23), a transversal aluminum foil controlling unit (27) and a sheet delivery unit (25).

According to the paper traveling sequence of the automatic die-cutting stamping machine of the platen flat double-set type of this creation, the position sequence of various units mentioned above on the machine is: paper conveying unit (20)+dieing unit of the first group (21)+aluminum foil controlling unit of the first group (22)+aluminum foil controlling unit of the second group (23)+dieing unit of the second group (24) (+transversal aluminum foil controlling unit (27))+sheet delivery unit (25).

The above mentioned sheet conveying unit (20) could implement the handing over of the sheet to the gripper row (32) manually or implement it to the gripper row (32) automatically. Every paper sheet is picked up sheet by sheet from the paper pile and is conveyed to a sheet conveying table. On the conveying table, every sheet must be positioned by leaning against the front guard gauge and side gauge. The front edge of the sheet after the positioning is clipped by the gripper row (32) one by one and is sent to the subsequent processing table. Two ends of the gripper row (32) are fixed on two enclosed and mutually parallel driving chains (30) at its two sides. The gripper row (32) moves in circulation with the driving chain (30). Its driving device is an intermittent driving mechanism, implementing the cycled alternative acting process of the gripper row's (32) moving and stopping.

The dieing unit (21) of the first group is a paper product processing unit, said unit includes the fixed platform (31), moving platform (33), the mechanism (34) implementing the movement of the moving platform, and the framework that bears the force produced by the mutual action of the fixed platform and the moving platform. The moving platform (33) uses the connecting rod mechanism or cam mechanism for implementing the up/down reciprocating movement, after auxiliary tools were mounted on two platforms, and when they contacted mutually said device produces a pressure, and thus the transfer printing is implemented. After mounted with the die-cutting or indenting tools separately, the fixed platform (31) and moving platform (33) could implement the sheet cutting or indenting function. After the heating system and stamping tools were assembled on the fixed platform (31), then the stamping function could be implemented. When the gripper row (32) carrying the paper sheet stops at said unit, the action of stamping or die-cutting is implement.

After the stamping (or indenting) of the sheet was completed at the dieing unit (21) of the first group, the gripper row (32) continues to bring the gripped sheet to the aluminum foil controlling unit (22) of the first group for making a stop. The aluminum controlling unit (22) of the first group is a control device controlling the conveying length of the aluminum foil (transfer printing material) to be stamped during every stamping. In which the sending (or drawing) mechanism and recovering mechanism of the transfer printing material are included for implementing the sending of the transfer printing material before every stamping and the recovering of the waster material after the stamping. The aluminum foil needs to pass through between the fixed platform and moving platform of the dieing unit, when the dieing unit (21) produces a pressure, the transfer printing is carried out.

Then, the gripper row continues to bring the gripped sheet to the aluminum foil controlling unit (23) of the second group for making a stop. Said aluminum controlling unit (23) of the second group is a control device providing the transfer printing material for the dieing unit (24) of the second group. The control principles of the aluminum foil controlling unit (22) of the first group and of the aluminum foil controlling unit (23) of the second group could use the same or different control manner.

And then, the sheet is sent by the gripper row to the dieing unit (24) of the second group. Said unit includes also the pressure producing mechanism of the fixed platform and moving platform. The driving principles of the dieing unit (21) of the first group and of the dieing unit (24) of the second group could use the same or different driving manner. The second stamping or the die-cutting after the stamping (or indenting) could be implemented for the sheet at the dieing unit (24) of the second group.

After passed several working units mentioned above, the sheet is sent to the sheet delivery unit (25). The sheet delivery unit (25) is a device used for delivering the printing product after it is stamped or die-cut and waste edge removed, and for uniformity making of the printing product. Said unit includes the mechanism that makes the gripper row release the sheet and the mechanism that makes the sheet delivered in uniformity.

Also as shown on Figure Two, both ends of the above mentioned gripper row (32) are fixed on two enclosed and mutually parallel driving chains (30) at its two sides. Said driving chains are the cycling enclosed type, and the chains (30) pass through the dieing units (21, 24) of the first and second groups, the aluminum foil controlling units (22, 23) of the first and second groups, and the sheet delivery unit (25).

Some gripper rows (32) move in circulation with the driving chains (30). Its driving device is an intermittent driving mechanism that could implement the cycling alternative action process of the moving and stopping of the gripper row (32). The stopping frequency of the gripper row (32) is coordinative and in accord with the reciprocating movement frequency of the moving platform (33), i.e. when the gripper row stops once, the moving platform (33) moves reciprocally once.

In order to implement the coordination and accordance of the movement of the moving platform (33) with the stopping of the gripper row (32) in two dieing units, it is necessary to ensure that the relative time should be kept constant for the movement law of two moving platforms. That is to say, the synchronous movement must be ensured for the movement of two moving platforms (33). Then it is necessary to use a driving mechanism (26) of the synchronous drive for the implementation. Said mechanism (26) could use two independent motors for implementing the movement synchronism, could use also the mechanically synchronous driving device driven by one motor to implement the movement synchronism.

For the automatic die-cutting stamping machine of the platen flat double-set type mentioned above, in brief, its feature is that two groups of the dieing unit are included, and every sheet only needs to be conveyed once by the sheet conveying unit then it could pass through two groups of dieing unit, for implementing the stamping twice or the stamping and die-cutting, and the synchronism of the movements of two dieing units could be implemented by one driving device.

For six working units in the automatic die-cutting stamping machine of the platen flat double-set type mentioned above, according to the front and back sequence of the stamping machine's paper traveling, there could be different combinations, for implementing same function. For example:

First Combination:

Sheet conveying unit (20)+dieing unit of the first group (21)+aluminum foil controlling unit of the first group (22)+aluminum foil controlling unit of the second group (23)+dieing unit of the second group (24)+sheet delivery unit (25).

Second Combination:

Sheet conveying unit (20)+dieing unit of the first group (21)+aluminum foil controlling unit of the first group (22)+dieing unit of the second group (24)+aluminum foil controlling unit of the second group (23)+sheet delivery unit (25).

As shown on Figure Three, one transversal aluminum foil controlling unit (27) could be increased also on two dieing units, for implementing more product processing functions. Said transversal aluminum foil control unit (27) is a control device controlling the conveying length of the aluminum foil (transfer printing material) to be stamped during every stamping. In which the sending (or drawing) mechanism and recovering mechanism of the transfer printing material are included, for implementing the sending of the transfer printing material before every stamping and the recovering of the waste material after the stamping. The aluminum foil needs to pass through between the fixed platform (31) and moving platform (33) of the dieing units (21, 24), when the dieing unit produces a pressure, the transfer printing is implemented. Its feature is that the passing through direction of the aluminum foil crosses vertically to the movement direction of the sheet.

It could be known from the detailed description mentioned above, the automatic die-cutting stamping machine of the platen flat double-set type of this creation could reach the purpose of increasing the product efficiency with the equal working speed, for accomplishing the product processing work that the traditional automatic die-cutting stamping machine of the plate platen type is unable to accomplish, at the same time, it could reduce the sheet traveling times of the sheet, shorten the time interval of processing many times, reduce the sheet deformation caused by the processing, increase the accuracy of chromatography of the repeated stamping, control effectively the waste product rate of the printing product, expand the fabricating scope of the stamping technology, and increase the counterfeit resistant ability, so that it reaches the predetermined purpose.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An automatic die-cutting stamping machine of the platen flat double-set type, includes:
a sheet conveying unit;
two dieing units;
two aluminum foil controlling units;
a transversal aluminum foil controlling unit; and
a sheet delivery unit
according to the paper traveling front and back sequence of the automatic die-cutting stamping machine, the position sequence of various units mentioned above on the machine is: paper conveying unit+dieing unit of the first group+aluminum foil controlling unit of the first group+aluminum foil controlling unit of the second group+dieing unit of the second group+transversal aluminum foil controlling unit+sheet delivery unit.

2. Based on the automatic die-cutting stamping machine of the platen flat double-set type mentioned in item 1 of the patent application scope, in which, the sheet conveying unit could implement the handing over of the sheet to the gripper row manually or implement it to the gripper row automatically; every paper sheet is picked up from the paper pile sheet by sheet and is conveyed to a sheet conveying table, on the conveying table, every sheet must be positioned by leaning against the front guard gauge and side gauge, the front edge of the sheet after the positioning is clipped by the gripper row one by one and is sent to the subsequent processing table, two ends of the gripper row are fixed on two enclosed and mutually parallel driving chains at its two sides, the gripper row moves in circulation with the driving chain, its driving device is an intermittent driving mechanism, implementing the cycled alternative acting process of the gripper row's moving and stopping.

3. Based on the automatic die-cutting stamping machine of the platen flat double-set type mentioned in item 1 of the patent application scope, in which, the dieing unit of the first group is a paper product processing unit, said unit includes the fixed platform, moving platform, the mechanism implementing the movement of the moving platform, and the framework that bears the force produced by the mutual action of the fixed platform and the moving platform; the moving platform uses the connecting rod mechanism or cam mechanism for implementing the up/down reciprocating movement, after auxiliary tools were mounted on two platforms, and when they contacted mutually said device produces a pressure, and thus the transfer printing is implemented; after mounted with the die-cutting or indenting tools separately, the fixed platform and moving platform could implement the sheet cutting or indenting function; after the heating system and stamping tools were assembled on the fixed platform, then the stamping function could be implemented; when the gripper row carrying the paper sheet stops at said unit, the action of stamping or die-cutting is implement.

4. Based on the automatic die-cutting stamping machine of the platen flat double-set type mentioned in item 1 of the patent application scope, in which, the aluminum controlling unit of the first group is a control device controlling the conveying length of the aluminum foil (transfer printing material) to be stamped during every stamping, in which the sending (or drawing) mechanism and recovering mechanism of the transfer printing material are included for implementing the sending of the transfer printing material before every stamping and the recovering of the waster material after the stamping; the aluminum foil needs to pass through between the fixed platform and moving platform of the dieing unit, when the dieing unit produces a pressure, the transfer printing is carried out.

5. Based on the automatic die-cutting stamping machine of the platen flat double-set type mentioned in item 1 of the patent application scope, in which, the aluminum controlling unit of the second group is a control device providing the transfer printing material for the dieing unit of the second group, the control principles of the aluminum foil controlling unit of the first group and of the aluminum foil controlling unit of the second group could use the same or different control manner.

6. Based on the automatic die-cutting stamping machine of the platen flat double-set type mentioned in item 1 of the patent application scope, in which, the dieing unit of the second group includes the pressure producing mechanism of the fixed platform and moving platform, the driving principles of the dieing unit of the first group and of the dieing unit of the second group could use the same or different driving manner; the second stamping or the die-cutting after the stamping (or indenting) could be implemented for the sheet at the dieing unit of the second group.

7. Based on the automatic die-cutting stamping machine of the platen flat double-set type mentioned in item 1 of the patent application scope, in which, the sheet delivery unit is a device used for delivering the printing product after it is stamped or die-cut and waste edge removed, and for uniformity making of the printing product, said unit includes the mechanism that makes the gripper row release the sheet and the mechanism that makes the sheet delivered in uniformity.

8. Based on the automatic die-cutting stamping machine of the platen flat double-set type mentioned in items 1 of the patent application scope, in which, both ends of the gripper row are fixed on two enclosed and mutually parallel driving chains at its two sides, said driving chains are the cycling enclosed type, and the chains pass through the dieing units of the first and second groups, the aluminum foil controlling units of the first and second groups, and the sheet delivery unit; some gripper rows move in circulation with the driving chains, its driving device is an intermittent driving mechanism that could implement the cycling alternative action process of the moving and stopping of the gripper row, the stopping frequency of the gripper row is coordinative and in accord with the reciprocating movement frequency of the moving platform, i.e. when the gripper row stops once, the moving platform moves reciprocally once.

9. Based on the automatic die-cutting stamping machine of the platen flat double-set type mentioned in items 2 of the patent application scope, in which, both ends of the gripper row are fixed on two enclosed and mutually parallel driving chains at its two sides, said driving chains are the cycling enclosed type, and the chains pass through the dieing units of the first and second groups, the aluminum foil controlling units of the first and second groups, and the sheet delivery unit; some gripper rows move in circulation with the driving chains, its driving device is an intermittent driving mechanism that could implement the cycling alternative action process of the moving and stopping of the gripper row, the stopping frequency of the gripper row is coordinative and in accord with the reciprocating movement frequency of the moving platform, i.e. when the gripper row stops once, the moving platform moves reciprocally once.

10. Based on the automatic die-cutting stamping machine of the platen flat double-set type mentioned in items 1 of the patent application scope, in which, the coordination and accordance of the movement of the moving platform with the stopping of the gripper row in two dieing units are implemented by a driving mechanism driven synchronously, said mechanism could use two independent motors for implementing the movement synchronism, could use also the mechanically synchronous driving device driven by one motor to implement the movement synchronism.

11. Based on the automatic die-cutting stamping machine of the platen flat double-set type mentioned in items 2 of the patent application scope, in which, the coordination and accordance of the movement of the moving platform with the stopping of the gripper row in two dieing units are implemented by a driving mechanism driven synchronously, said mechanism could use two independent motors for implementing the movement synchronism, could use also the mechanically synchronous driving device driven by one motor to implement the movement synchronism.

12. Based on the automatic die-cutting stamping machine of the platen flat double-set type mentioned in items 8 of the patent application scope, in which, the coordination and accordance of the movement of the moving platform with the stopping of the gripper row in two dieing units are implemented by a driving mechanism driven synchronously, said mechanism could use two independent motors for implementing the movement synchronism, could use also the mechanically synchronous driving device driven by one motor to implement the movement synchronism.

13. Based on the automatic die-cutting stamping machine of the platen flat double-set type mentioned in item 1 of the patent application scope, in which, according to the front and back sequence of the paper traveling on the automatic die-cutting stamping machine, the position sequence of every unit on the machine could be:
sheet conveying unit+dieing unit of the first group+aluminum foil controlling unit of the first group+aluminum foil controlling unit of the second group+dieing unit of the second group+sheet delivery unit.

14. Based on the automatic die-cutting stamping machine of the platen flat double-set type mentioned in item 1 of the patent application scope, in which, according to the front and back sequence of the paper traveling on the automatic die-cutting stamping machine, the position sequence of every unit on the machine could be:
sheet conveying unit+dieing unit of the first group+aluminum foil controlling unit of the first group+dieing unit of the second group+aluminum foil controlling unit of the second group+sheet delivery unit.

15. Based on the automatic die-cutting stamping machine of the platen flat double-set type mentioned in item 1 of the patent application scope, in which, one transversal aluminum foil controlling unit increased on two dieing units is included, said transversal aluminum foil control unit is a control device controlling the conveying length of the aluminum foil (transfer printing material) to be stamped during every stamping, including the sending (or drawing) mechanism and recovering mechanism of the transfer printing material, for implementing the sending of the transfer printing material before every stamping and the recovering of the waste material after the stamping, the aluminum foil needs to pass through between the fixed platform and moving platform of the dieing units, when the dieing unit produces a pressure, the transfer printing is implemented, its feature is that the passing through direction of the aluminum foil crosses vertically to the movement direction of the sheet.

16. Based on the automatic die-cutting stamping machine of the platen flat double-set type mentioned in item 10 of the patent application scope, in which, one transversal aluminum foil controlling unit increased on two dieing units is included, said transversal aluminum foil control unit is a control device controlling the conveying length of the aluminum foil (transfer printing material) to be stamped during every stamping, including the sending (or drawing) mechanism and recovering mechanism of the transfer printing material, for implementing the sending of the transfer printing material before every stamping and the recovering of the waste material after the stamping, the aluminum foil needs to pass through between the fixed platform and moving platform of the dieing units, when the dieing unit produces a pressure, the transfer printing is implemented, its feature is that the passing through direction of the aluminum foil crosses vertically to the movement direction of the sheet.

17. Based on the automatic die-cutting stamping machine of the platen flat double-set type mentioned in item 11 of the patent application scope, in which, one transversal aluminum foil controlling unit increased on two dieing units is included, said transversal aluminum foil control unit is a control device controlling the conveying length of the aluminum foil (transfer printing material) to be stamped during every stamping, including the sending (or drawing) mechanism and recovering mechanism of the transfer printing material, for implementing the sending of the transfer printing material before every stamping and the recovering of the waste material after the stamping, the aluminum foil needs to pass through between the fixed platform and moving platform of the dieing units, when the dieing unit produces a pressure, the transfer printing is implemented, its feature is that the passing through direction of the aluminum foil crosses vertically to the movement direction of the sheet.
